(19) United States
(12) Patent Application Publication
(10) Pub. No.: US 2011/0254817 A1
(43) Pub. Date: Oct. 20, 2011

(54) DISPLAY, CONTROL CIRCUIT THEREOF, AND METHOD OF DISPLAYING IMAGE DATA

(75) Inventor: Sheng-Tsai CHANG, Changhua County (TW)

(73) Assignee: NUVOTON TECHNOLOGY CORPORATION, Hsinchu (TW)

(21) Appl. No.: 13/085,503

(22) Filed: Apr. 13, 2011

(30) Foreign Application Priority Data
Apr. 15, 2010 (TW) 099111826

(51) Int. Cl. G09G 5/00

(52) U.S. Cl. 345/204

(57) ABSTRACT

A method of displaying image data includes the steps as follows. Image data with various data bits are transmitted, and one of the image data is selectively received and processed to output N-bit image data, where 0<N, N is a positive integer. The N-bit image data are stored, and a display panel is driven in accordance with the stored N-bit image data. The N-bit image data corresponding to one of the image data with the various data bits are displayed by the display panel. A display device and a control circuit thereof are also disclosed herein.

### RELATED APPLICATIONS

This application claims priority to Taiwan Patent Application Serial Number 99111826, filed Apr. 15, 2010, which is herein incorporated by reference.

### BACKGROUND

1. Technical Field

The present disclosure relates to a display device and method. More particularly, the present disclosure relates to a display and method of displaying image data with various bits.

2. Description of Related Art

For a conventional display device capable of displaying images having 2^{N} colors, it usually displays N-bit image data when displaying the images. For example, a display device capable of displaying images with 64 (2⁶) colors usually displays 6-bit image data, and when the frame has a resolution of C×S, the frame shown on the display is represented by the image data of 6×C×S bits.

However, the foregoing display device may have problems of consuming too many resources when displaying images. Specifically, when the display device merely displays the image frames without requiring many resources for the moment, e.g. the display device displays images having 2^{M} colors, where 0<M<N, or when the display device merely displays a portion of image frames without requiring many resources for the moment, e.g. a portion of frame showing the image having 2^{N} colors and the other portion of frame showing the image having 2^{P} colors, where 0<P<N, the system resources (e.g. data transmission bandwidth, required memory, etc.) which are unnecessary for the images will be wasted if the images are still processed and displayed by the manner of displaying the N-bit image data. Thus, if the types of image data are not considered but only the same displaying manner is used to process and display the image data, the system resources will be inevitably wasted.

### SUMMARY

In accordance with one embodiment of the present invention, a display is provided. The display includes a host controller, a data processor, a storing unit and a driver. The host controller is configured for transmitting a plurality of image data with various data bits. The data processor is configured for selectively processing one of the image data to output N-bit image data, and includes a first transforming unit. The first transforming unit includes a first memory and a first lookup table, in which the first lookup table is stored in the first memory and defines 2^{M} image values and 2^{M} image data, the 2^{M} image values correspond to M-bit image data, the 2^{M} image data correspond to the 2^{M} image values and are represented by N bits. The first transforming unit is configured for receiving the M-bit image data of the image data from the host controller and outputting N-bit image data in accordance with the first lookup table, wherein 0<M<N, M and N are positive integers. The storing unit is configured for storing the N-bit image data outputted by the data processor. The driver is configured for receiving the N-bit image data stored by the storing unit and driving a display panel in accordance with the N-bit image data stored by the storing unit, to display on the display panel the N-bit image data corresponding to one of the image data with the various data bits.

In accordance with another embodiment of the present invention, a method of displaying image data is provided. The method includes the steps as follows. A plurality of image data with various data bits are transmitted, and one of the image data is selectively received and processed to output N-bit image data, wherein 0<N, N is a positive integer. The N-bit image data are stored, and a display panel is driven in accordance with the stored N-bit image data. The N-bit image data corresponding to one of the image data with the various data bits are displayed by the display panel.

In accordance with yet another embodiment of the present invention, a control circuit is provided. The control circuit includes a data processor, a storing unit and a driver. The data processor is configured for selectively processing one of a plurality of image data with various data bits to output N-bit image data. The data processor includes a first transforming unit including a first memory and a first lookup table, in which the first lookup table is stored in the first memory and defines 2^{M} image values and 2^{M} image data, the 2^{M} image values correspond to M-bit image data, the 2^{M} image data correspond to the 2^{M} image values and are represented by N bits. The first transforming unit is configured for receiving the M-bit image data of the image data and outputting N-bit image data in accordance with the first lookup table, wherein 0<M<N, M and N are positive integers. The storing unit is configured for storing the N-bit image data outputted by the data processor. The driver is configured for receiving the N-bit image data stored by the storing unit and driving a display panel in accordance with the N-bit image data stored by the storing unit, to display on the display-panel the N-bit image data corresponding to one of the image data with the various data bits.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiments, with reference to the accompanying drawings as follows:

FIG. 1 is a diagram of a display device in accordance with one embodiment of the present invention;

FIG. 2 is a diagram of the first lookup table shown in FIG. 1 in accordance with one embodiment of the present invention;

FIG. 3 is a diagram of the display device in accordance with another embodiment of the present invention; and

FIG. 4 is a flow chart of a method of displaying image data in accordance with one embodiment of the present invention.

### DESCRIPTION OF THE EMBODIMENTS

In the following description, several specific details are presented to provide a thorough understanding of the embodiments of the present invention. One skilled in the relevant art will recognize, however, that the present invention can be practiced without one or more of the specific details, or in combination with or with other components, etc. In other instances, well-known implementations or operations are not shown or described in detail to avoid obscuring aspects of various embodiments of the present invention.

The terms used in this specification generally have their ordinary meanings in the art and in the specific context where each term is used. The use of examples anywhere in this specification, including examples of any terms discussed herein, is illustrative only, and in no way limits the scope and meaning of the invention or of any exemplified term. Likewise, the present invention is not limited to various embodiments given in this specification.

As used herein, the terms “comprising,” “including,” “having,” “containing,” “involving,” and the like are to be understood to be open-ended, i.e., to mean including but not limited to.

Reference throughout the specification to “one embodiment” or “an embodiment” means that a particular feature, structure, implementation, or characteristic described in connection with the embodiment is included in at least one embodiment of the present invention. Thus, uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

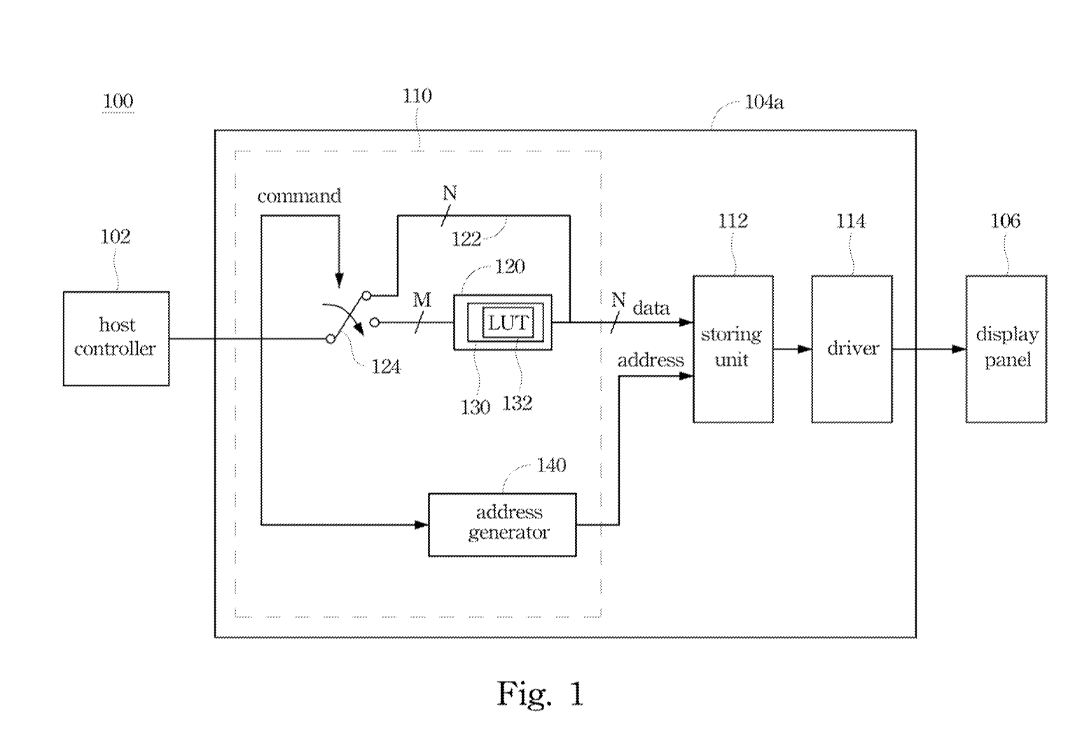

FIG. 1 is a diagram of a display device in accordance with one embodiment of the present invention. The display device 100 may include a host controller 102, a control circuit 104a and a display panel 106. Substantially, the host controller 102 can be configured to control the control circuit 104a and transmit a plurality of image data with various data bits to the control circuit 104a, for the control circuit 104a to process. Then, the control circuit 104a can transmit the processed image data to the display panel 106, such that the image data can be displayed on the display panel 106.

In the present embodiment, the host controller 102 may transmit N-bit image data or M-bit image data according to the demand of frames to be displayed, in which 0<M<N, M and N are positive integers. Moreover, the host controller 102 also may include a memory (e.g. read only memory, ROM), and the image data can be stored in the memory. The host controller 102 then outputs the image data when the display device 100 displays the images.

The control circuit 104a may include a data processor 110, a storing unit 112 and a driver 114. The data processor 110 can be configured for selectively processing one of the image data outputted by the host controller 102, to output the N-bit image data. The storing unit 112 can be configured for storing the N-bit image data outputted by the data processor 110. The driver 114 can be configured for receiving the N-bit image data stored by the storing unit 112 and for driving the display panel 106 in accordance with the N-bit image data stored by the storing unit 112, to display on the display panel 106 the N-bit image data corresponding to one of the image data with the various data bits.

For example, when the host controller 102 transmits the N-bit image data, the data processor 110 can be set to process the N-bit image data and to output the processed N-bit image data for the storing unit 112 and the driver 114 to process, so as to be displayed on the display panel 106. On the other hand, when the host controller 102 transmits the M-bit image data, the data processor 110 can be set to process the M-bit image data and to still output the N-bit image data for the storing unit 112 and the driver 114 to process, so as to be displayed on the display panel 106.

In the present embodiment, the host controller 102 can first send various commands according to the image data to be transmitted, so as to control the data processor 110; then, the host controller 102 transmits the image data to be processed by the data processor 110 and displayed on the display panel 106. For example, the host controller 102 sends command A for controlling the data processor 110, so as to inform the data processor 110 that the image data which is to be later displayed are the M-bit image data, or the host controller 102 sends command A for controlling the data processor 110, so as to inform the data processor 110 that the image data which is to be later displayed are the N-bit image data.

Furthermore, the data processor 110 may further include a first transforming unit 120, an N-bit image data transmission channel 122 and a switch 124. The first transforming unit 120 can be coupled between the host controller 102 and the storing unit 112, and include a first memory 130 and a first lookup table (LUT) 132, in which the first memory 130 may be a random access memory (RAM), a read only memory (ROM) or a register. The first lookup table 132 is stored in the first memory 130 and defines 2^{M} image values and 2^{M} image data, in which the 2^{M} image values correspond to the M-bit image data, and the 2^{M} image data correspond to the 2^{M} image values and are represented by N bits. In other words, the first lookup table 132 not only defines the 2^{M} image values corresponding to the M-bit image data, but also further defines the 2^{M} image data corresponding to the 2^{M} image values and represented by N bits at the same time. In the present embodiment, the foregoing image data may represent color data, and the foregoing image values may represent color values.

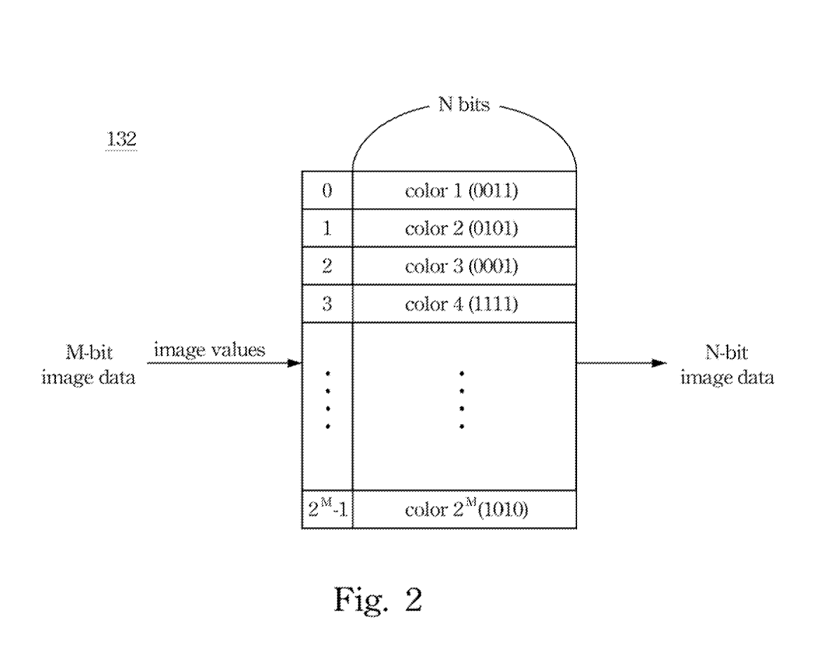

In addition, the first transforming unit 120 can be configured for receiving the M-bit image data of the image data from the host controller 102 and outputting the N-bit image data in accordance with the first lookup table 132. FIG. 2 is a diagram of the first lookup table shown in FIG. 1 in accordance with one embodiment of the present invention. Specifically, when the first transforming unit 120 receives the M-bit (e.g. M=3) image data, the M-bit image data may respectively correspond to the 2^{M} image values (i.e. 0˜2^{M}−1) in the first lookup table 132, and then the corresponding 2^{M} image data represented by N (e.g. N=4) bits are obtained by respectively looking up the image values 0˜2^{M}−1 in the first lookup table 132, thus outputting the N-bit image data.

In the present embodiment, the foregoing image data may represent color data, the foregoing image values may represent color values, and 2^{M} colors correspond to the 2^{M} color data can be selected from the originally existing 2^{N} colors (M<N) and encoded according to the M-bit color values (0˜2^{M}−1). For example, when M=3 and N=4, color values are 0˜7, and at the moment the selected 8 (2³) colors (i.e. color 1˜8) can be encoded respectively corresponding to the color values 0˜7 in the lookup table, such as color 1 (0011) corresponding to color value 0, color 2 (0101) corresponding to color value 1, color 3 (0001) corresponding to color value 2, and so on. Therefore, when the host controller 102 transmits the M-bit (e.g. M=3) color data for being displayed on the display panel 106, the colors 1˜8 corresponded by the color values 0˜7 can be outputted to be displayed on the display panel 106.

The N-bit image data transmission channel 122 may be coupled between the host controller 102 and the storing unit 112 and coupled in parallel with the first transforming unit 120, for transmitting the N-bit image data of the image data. When the host controller 102 transmits the N-bit image data, the host controller 102 can directly transmit the N-bit image data to the storing unit 112 through the N-bit image data transmission channel 122.

The switch 124 can be controlled by the host controller 102 to selectively connect the host controller 102 with one of the first transforming unit 120 and the N-bit image data transmission channel 122. In other words, when the host controller 102 is going to transmit the N-bit image data, the host controller 102 can send the commands to the switch 124 in advance such that the switch 124 connects the host 102 controller with the N-bit image data transmission channel 122; on the other hand, when the host controller 102 is going to transmit the M-bit image data, the host controller 102 can send the commands to the switch 124 in advance such that the switch 124 connects the host 102 controller with the first transforming unit 120.

Moreover, the data processor 110 may further include an address generator 140 which may be coupled between the host controller 102 and the storing unit 112, for setting corresponding storing addresses in the storing unit 112 in accordance with the image data transmitted from the host controller 102, such that the image data are appropriately stored in the storing unit 112 in accordance with the storing addresses.

Since the display device 100 sometimes only displays image frames without requiring many resources (for example, only displaying images with 2^{M} colors, 0<M<N), if the foregoing embodiments in the present invention are applied, not only can the host controller 102 transmit a smaller volume of the image data in this condition for the control circuit 104a to process and for the display panel 106 to display, the host controller 102 also merely needs to store the smaller volume of the image data when the host controller 102 has to temporarily store, such that the loading for the host controller 102 is not too heavy.

On the other hand, if the display device 100 merely displays a portion of image frames without requiring many resources (e.g. a portion of frame showing the image having 2^{N} colors and the other portion of frame showing the image having 2^{M} colors, where 0<M<N), the control circuit 104a can also be employed to separately process the image data with various bits, such that the image data with various bits is capable of being processed according to the required system resources (e.g. required data transmission bandwidth, required memory, etc.) and being displayed on the display panel 106.

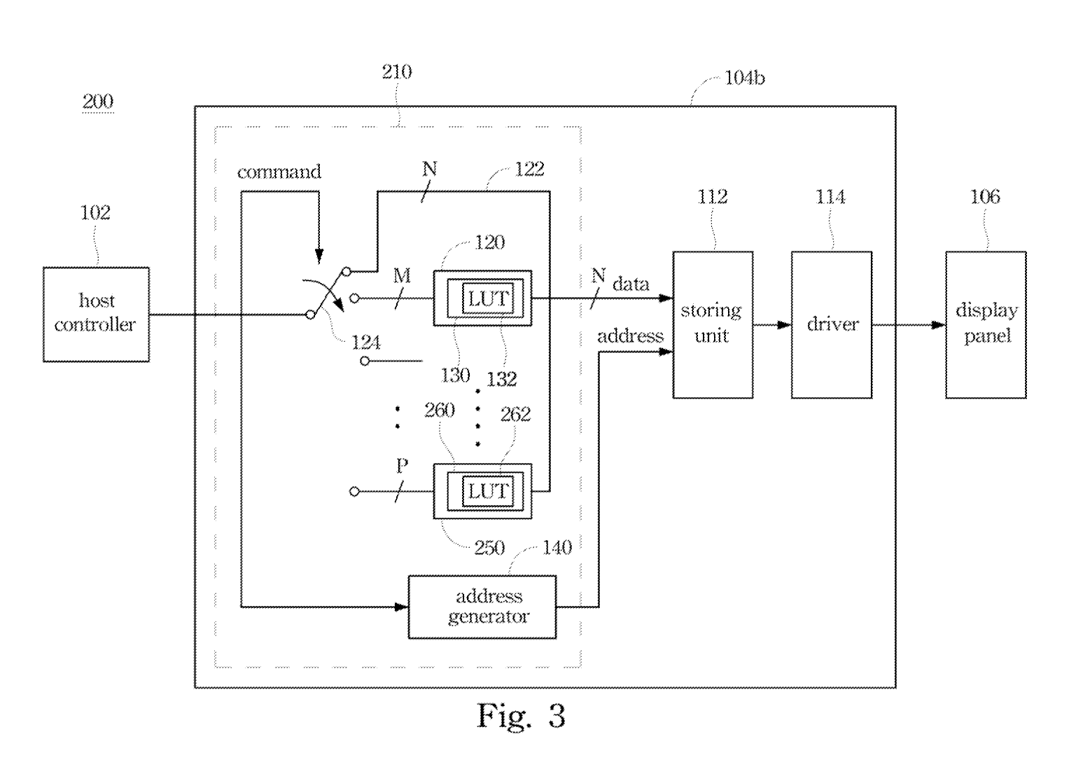

FIG. 3 is a diagram of the display device in accordance with another embodiment of the present invention. Compared to FIG. 1, the host controller 102 in the present embodiment may transmit P-bit image data according to the demand of frames to be displayed, in which 0<M<N, 0<P<N, where M, P and N are positive integers. In the present embodiment, P can be designed to be smaller or larger than M in practice. The data processor 210 in the control circuit 104b of the display device 200 can selectively process one of the image data outputted by the host controller 102 (i.e. N-bit, M-bit or P-bit image data). When the host controller 102 transmits the N-bit, M-bit or P-bit image data, the data processor 210 can be set to process the N-bit, M-bit or P-bit image data and to consistently output the N-bit image data for the storing unit 112 and the driver 114 to process, so as to be displayed on the display panel 106.

Furthermore, compared to FIG. 1, the data processor 210 may further include a second transforming unit 250. The second transforming unit 250 can include a second memory 260 and a second lookup table 262. The second transforming unit 250 can be connected in a way similar to the first transforming unit 120, and arrangements of the second memory 260 and the second lookup table 262 can be similar to the first memory 130 and the first lookup table 132, in which the most obvious difference therebetween is that the P-bit image data are processed.

In addition, the second transforming unit 250 in operation can be similar to the first transforming unit 120, in which the most obvious difference therebetween is that the P-bit image data are processed.

On the other hand, the switch 124 can selectively connect the host 102 controller with one of the first transforming unit 120, the second transforming unit 250 and the N-bit image data transmission channel 122. In other words, when the host controller 102 is going to transmit the P-bit image data, the host controller 102 can send the commands to the switch 124 in advance such that the switch 124 connects the host controller 102 with the second transforming unit 250.

The first lookup table 132 and second lookup table 262 can separately be built in the first transforming unit 120 or the second transforming unit 250, or can be programmably set by the host controller 102. In other words, when the first lookup table 132 or second lookup table 262 needs to change in order to meet the image data with various data bits, the host controller 102 can perform programming operations to the first lookup table 132 or second lookup table 262 by sending the commands to the first transforming unit 120 or the second transforming unit 250.

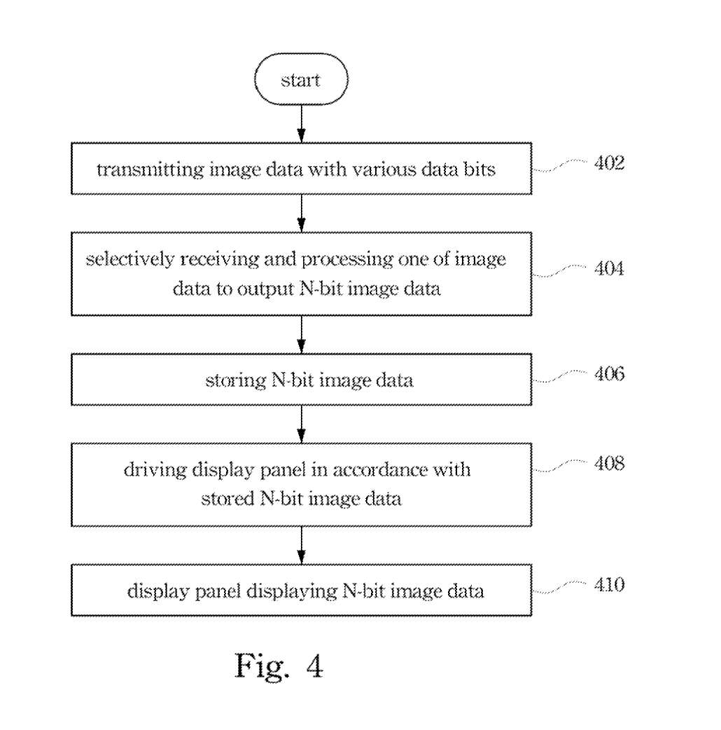

FIG. 4 is a flow chart of a method of displaying image data in accordance with one embodiment of the present invention. Refer to FIG. 1 and FIG. 4 at the same time. First, a plurality of image data with various data bits are transmitted (Step 402), in which this step can be performed by, for example, the host controller 102. Then, the step of selectively receiving and processing one of the image data to output the N-bit image data is performed (Step 404), in to which 0<N, N is a positive integer, and this step can be performed by, for example, the data processor 110. After that, the N-bit image data are stored (Step 406), in which this step can be performed by, for example, the storing unit 112. Afterwards, the display panel 106 is driven in accordance with the stored N-bit image data (Step 408), in which this step can be performed by, for example, the driver 114. Then, the display panel 106 displays the N-bit image data corresponding to one of the image data with the various data bits (Step 410).

In the present embodiment, the foregoing method of displaying image data may further include the steps as follows. First, at least one lookup table (e.g. first lookup table 132) is stored in the host controller 102. Then, when the image data with the various data bits are transmitted, the host controller 102 outputs the lookup table to a memory (e.g. first memory 130) located in first transforming unit 120, and the lookup table is saved in the memory accordingly. Furthermore, the N-bit image data are outputted in accordance with the lookup table. In another embodiment, the lookup table (e.g. first lookup table 132) also can be stored in the memory (e.g. first memory 130) in advance.

Moreover, in the present embodiment, the foregoing method of displaying image data may further include the step of setting corresponding storing addresses in accordance with the transmitted image data, for storing the outputted N-bit image data.

In addition, the step of selectively receiving and processing one of the image data may further include the steps of receiving M-bit image data of the image data and outputting the N-bit image data in accordance with the first lookup table 132 related to the M-bit image data, or include the steps of receiving P-bit (P can be larger or smaller than M) image data of the image data and outputting the N-bit image data in accordance with the second lookup table 262 related to the P-bit image data, or include the step of directly transmitting the N-bit image data of the image data through the N-bit image data transmission channel.

Furthermore, referring to FIG. 1 and FIG. 4, in the method of displaying image data shown in FIG. 4, Step 404 further can include the following steps: (a) outputting the N-bit image data in accordance with the first lookup table 132 and M-bit image data of the image data; (b) transmitting the N-bit image data of the image data through the N-bit image data transmission channel; and (c) performing one of the steps (a) and (b) in accordance with the transmitted image data.

On the other hand, referring to FIG. 3 and FIG. 4, in the method of displaying image data shown in FIG. 4, Step 404 can otherwise include the following steps: (a) outputting the N-bit image data in accordance with the first lookup table 132 and the M-bit image data of the image data; (b) outputting the N-bit image data in accordance with the second lookup table 262 and the P-bit image data of the image data; (c) transmitting the N-bit image data of the image data through the N-bit image data transmission channel; and (d) performing one of the steps (a), (b) and (c) in accordance with the transmitted image data.

For the foregoing embodiments, the display device and method of displaying image data can be applied, during transmitting and displaying the image data, to prevent from transmitting unnecessary and unused image data from the transmitting terminal (e.g. host controller). As a result, the memory space of the transmitting terminal (e.g. host controller) can thus be saved, and the image data required to be transmitted can be reduced at the same time, to further reduce the data transmission bandwidth between the transmitting terminal and the displaying terminal (e.g. display panel).

As is understood by a person skilled in the art, the foregoing embodiments of the present invention are illustrative of the present invention rather than limiting of the present invention. It is intended to cover various modifications and similar arrangements included within the spirit and scope of the appended claims, the scope of which should be accorded with the broadest interpretation so as to encompass all such modifications and similar structures.

What is claimed is:

1. A display, comprising:
a host controller for transmitting a plurality of image data with various data bits;
a data processor for selectively processing one of the image data to output N-bit image data, the data processor comprising:
a first transforming unit comprising a first memory and a first lookup table, the first lookup table stored in the first memory, the first lookup table defining 2^{M} image values and 2^{M} image data, the 2^{M} image values corresponding to M-bit image data, the 2^{M} image data corresponding to the 2^{M} image values and represented by N bits, the first transforming unit configured for receiving the M-bit image data of the image data from the host controller and outputting N-bit image data in accordance with the first lookup table, wherein 0<M<N, M and N are positive integers;
a storing unit for storing the N-bit image data outputted by the data processor; and
a driver for receiving the N-bit image data stored by the storing unit and driving a display panel in accordance with the N-bit image data stored by the storing unit, to display on the display panel the N-bit image data corresponding to one of the image data with the various data bits.

2. The display as claimed in claim 1, wherein the image data represent color data, and the image values represent color values.

3. The display as claimed in claim 1, wherein the data processor further comprises:
a second transforming unit comprising a second memory and a second lookup table, the second lookup table stored in the second memory, the second lookup table defining 2^{P} image values and 2^{P} image data, the 2^{P} image values corresponding to P-bit image data, the 2^{P} image data corresponding to the 2^{P} image values and represented by N bits, the second transforming unit configured for receiving the P-bit image data of the image data from the host controller and outputting the N-bit image data in accordance with the second lookup table, wherein 0<P<N, P is a positive integer.

4. The display as claimed in claim 3, wherein the data processor further comprises:
an N-bit image data transmission channel coupled between the host controller and the storing unit, wherein the host controller transmits the N-bit image data through the N-bit image data transmission channel to the storing unit when transmitting the N-bit image data.

5. The display as claimed in claim 4, wherein the data processor further comprises:
a switch controlled by the host controller to selectively connect the host controller with one of the first transforming unit, the second transforming unit and the N-bit image data transmission channel.

6. The display as claimed in claim 1, wherein the data processor further comprises:
an N-bit image data transmission channel coupled between the host controller and the storing unit, wherein the host controller transmits the N-bit image data through the N-bit image data transmission channel to the storing unit when transmitting the N-bit image data.

7. The display as claimed in claim 6, wherein the data processor further comprises:
a switch controlled by the host controller to selectively connect the host controller with one of the first transforming unit and the N-bit image data transmission channel.

8. The display as claimed in claim 1, wherein the data processor further comprises:
an address generator coupled between the host controller and the storing unit, for setting corresponding storing addresses in the storing unit in accordance with the image data transmitted from the host controller.

9. The display as claimed in claim 1, wherein the first lookup table is built in the first transforming unit or programmably set by the host controller.

10. The display as claimed in claim 1, wherein the first memory is a random access memory (RAM), a read only memory (ROM) or a register.

11. A method of displaying image data, comprising:
transmitting a plurality of image data with various data bits;
selectively receiving and processing one of the image data to output N-bit image data, wherein 0<N, N is a positive integer;
storing the N-bit image data;
driving a display panel in accordance with the stored N-bit image data; and
the display panel displaying the N-bit image data corresponding to one of the image data with the various data bits.

12. The method as claimed in claim 11, further comprising:
storing at least one lookup table in a host controller;
when the image data with the various data bits being transmitted, the host controller outputting the lookup table to a memory; and
outputting the N-bit image data in accordance with the lookup table.

13. The method as claimed in claim 11, wherein the step of selectively receiving and processing one of the image data further comprises:
receiving M-bit image data of the image data; and
outputting the N-bit image data in accordance with a first lookup table, wherein the first lookup table defines 2^{M} image values and 2^{M} image data, the 2^{M} image values correspond to the M-bit image data, the 2^{M} image data correspond to the 2^{M} image values and are represented by N bits, wherein 0<M<N, M is a positive integer.

14. The method as claimed in claim 13, wherein the step of selectively receiving and processing one of the image data further comprises:
transmitting the N-bit image data of the image data through an N-bit image data transmission channel.

15. The method as claimed in claim 13, wherein the step of selectively receiving and processing one of the image data further comprises:
receiving P-bit image data of the image data; and
outputting the N-bit image data in accordance with a second lookup table, wherein the second lookup table defines 2^{P} image values and 2^{P} image data, the 2^{P} image values correspond to the P-bit image data, the 2^{P} image data correspond to the 2^{P} image values and are represented by N bits, wherein 0<P<N, P is a positive integer.

16. The method as claimed in claim 11, wherein the step of selectively receiving and processing one of the image data further comprises:
(a) outputting the N-bit image data in accordance with a first lookup table and M-bit image data of the image data, wherein the first lookup table defines 2^{M} image values and 2^{M} image data, the 2^{M} image values correspond to the M-bit image data, the 2^{M} image data correspond to the 2^{M} image values and are represented by N bits, wherein 0<M<N, M is a positive integer;
(b) transmitting the N-bit image data of the image data through an N-bit image data transmission channel; and
(c) performing one of the steps (a) and (b) in accordance with the transmitted image data.

17. The method as claimed in claim 11, further comprising:
setting corresponding storing addresses in accordance with the transmitted image data, for storing the N-bit image data.

18. A control circuit, comprising:
a data processor for selectively processing one of a plurality of image data with various data bits to output N-bit image data, the data processor comprising:
a first transforming unit comprising a first memory and a first lookup table, the first lookup table stored in the first memory, the first lookup table defining 2^{M} image values and 2^{M} image data, the 2^{M} image values corresponding to M-bit image data, the 2^{M} image data corresponding to the 2^{M} image values and represented by N bits, the first transforming unit configured for receiving the M-bit image data of the image data and outputting N-bit image data in accordance with the first lookup table, wherein 0<M<N, M and N are positive integers;
a storing unit for storing the N-bit image data outputted by the data processor; and
a driver for receiving the N-bit image data stored by the storing unit and driving a display panel in accordance with the N-bit image data stored by the storing unit, to display on the display panel the N-bit image data corresponding to one of the image data with the various data bits.

19. The control circuit as claimed in claim 18, further comprising:
a second transforming unit comprising a second memory and a second lookup table, the second lookup table stored in the second memory, the second lookup table defining 2^{P} image values and 2^{P} image data, the 2^{P} image values corresponding to P-bit image data, the 2^{P} image data corresponding to the 2^{P} image values and represented by N bits, the second transforming unit configured for receiving the P-bit image data of the image data and outputting the N-bit image data in accordance with the second lookup table, wherein 0<P<N, P is a positive integer.

20. The control circuit as claimed in claim 18, further comprising:
an N-bit image data transmission channel coupled in parallel with first transforming unit, for transmitting the N-bit image data of the image data.
